(19) United States
(12) Patent Application Publication
(10) Pub. No.: US 2005/0189677 A1
(43) Pub. Date: Sep. 1, 2005

(54) Method for producing a cast of hydrated thermo-set materials with polyurethane elastomer molds

(76) Inventor: Steven Lucka, Perris, CA (US)

Correspondence Address: Coudert Brothers LLP;Two Palo Alto Square, 4th Floor, 3000 El Camino Real, Palo Alto, CA, 94306, US

(21) Appl. No.: 10/787,703

(22) Filed: Feb. 26, 2004

(51) Int. Cl. B28B 1/14; B29C 33/38; B29C 71/02

(52) U.S. Cl. 264/236; 264/333; 264/334; 264/337

(57) ABSTRACT

The method of the present invention is directed to solving the demolding problem during the casting of hydrated thermo-set materials. The method includes the steps of pouring a fluid thermo-set material into a mold of a polyurethane elastomer containing at least about 5 percent of a hydrophobic additive based on the total weight of the elastomer, curing the thermo-set material within the mold over a period of time, and releasing the thermo-set material from the mold.

### FIELD OF THE INVENTION

The present invention relates to method for producing hydrated thermo-set casts using molds of a polyurethane elastomer and more effectively releasing the cured hydrated thermo-set from the mold.

### BACKGROUND OF THE INVENTION

The use of a release additive or agent to facilitate the de-molding of a hydrated thermo-set material such as concrete is well known because of the problem of a fully hydrated, i.e., a cured, concrete adhering to the walls of the mold. This de-molding problem has been solved by applying the mold release agents to the surfaces of iron or steel molds, to facilitate the release of the cured concrete; see U.S. Pat. Nos. 3,941,864 and 5,447,563. A similar solution is to cover the walls of the mold coming into contact with the concrete with a mold release composition comprising a resin, which is a silicone copolymer; see U.S. Pat. No. 6,309,577.

Polyurethane molds have long been used for producing casts of hydrated thermo-set materials such as concrete decorative designs and surfaces and building products. However, the use of polyurethane molds does not overcome the de-molding problem because fully hydrated concrete will strongly adhere to such molds. U.S. Pat. No. 5,783,135 describes a solution to this problem by use of a de-molding apparatus.

Concrete form molders have applied various mold release agents to the outside surface of the polyurethane mold to facilitate the release of the cured concrete from the mold. However, this solution still has problems. It has been found that the improper and non-uniform application of these mold release agents have resulted in failures in the field due to the mold tearing during removal from the concrete.

What is needed is a very cost effective method for de-molding concrete from polyurethane elastomer molds that does not result in mold tearing. There is also a need for a method that enables the concrete molder to reduce or eliminate the need for coating the surface of the polyurethane mold with release agents.

### SUMMARY OF THE INVENTION

The method of the present invention solves the de-molding problem from polyurethane elastomer molds during the casting of hydrated thermo-set materials without the external application of release agents on the molds. The method includes the steps of pouring a fluid thermo-set material into a mold of a polyurethane elastomer containing at least about 5 percent of a hydrophobic additive based on the total weight of the elastomer, curing the thermo-set material within the mold over a period of time, and releasing the thermo-set material from the mold.

A further understanding of the invention can be had from the detailed discussion of the specific embodiments below. For purposes of clarity, this discussion refers to methods and concepts in terms of a specific example of pouring an aqueous mixture comprising Portland cement into a polyurethane mold and removing the resulting hydrated concrete from the mold. However, the method of the present invention may be used to pour other aqueous mixtures of thermo-set materials including gypsum and clay into polyurethane molds and then removing the hydrated plaster or clay from the mold. It is therefore intended that the invention not be limited by the discussion of specific embodiments.

### DETAILED DESCRIPTION OF THE INVENTION

The molds used in the method of the present invention are made from a catalytically cured polyurethane elastomer comprising a polyisocyanate preferably having an average functionality of about 2.0, or greater; a polyol or blend of polyols preferably having a molecular weight in the range of about 50 to about 7000; and a hydrophobic additive. The catalytically cured elastomer preferably has a Durometer hardness in the range of about 5 (Shore A) to 80 (Shore D 80).

The hydrophobic agents all have the properties of being hydrophobic and are selected from aromatic hydrocarbon oils, solvents with flash points greater than 100° F., chlorinated hydrocarbons, castor oil, silicone fluid, and mixtures of such additives. The amount of the hydrophobic additive added to the blend of polyisocyanate and polyol is in the range of about 5 to about 80, preferably about 20 to about 65, weight percent, based on the total weight of the elastomer.

Hydrophobic aromatic hydrocarbon oils that have been found to be particularly effective include Mariflex 1000 commercially available from Maris Polymers; and Crowley 530A supplied by Crowley Chemical Company.

Other suitable hydrophobic additives include solvents having flash point greater than 100° F. include Hysol 150 supplied by Ashland Chemical Company.

Chlorinated hydrocarbons that are useful as hydrophobic additives include chlorinated paraffins. Particularly effective chlorinated hydrocarbons are chlorinated paraffins sold under the name of Chlorowax LV supplied by Dover Chemical Corporation.

Suitable silicon fluids useful as hydrophobic release additives include Ease Release 300 sold by Mann Formulated Products, DC200 supplied by Dow Corning Silicones.

Particularly suitable polyisocyanates for use in the elastomers used in the molds of the present invention can be unmodified isocyanates, modified polyisocyanates, or isocyanate prepolymers and can include aliphatic, cycloaliphatic, araliphatic, aromatic, and heterocyclic polyisocyanates. A selected few examples of suitable isocyanates include ethylene diisocyanate; 1,4-tetramethylene diisocyanate; 1,6-hexamethylene diisocyanate; 1,12-dodecane diisocyanate; cyclobutane-1,3-diisocyanate; cyclohexane-1,3- and -1,4-diisocyanate, and mixtures of these isomers, and diphenylmethane-2,4′- and/or -4,4′-diisocyanate (“MDI”).

In general, it is preferred to use in the molds of the present invention a diphenylmethane diisocyanate (MDI) by itself or blended with a modified diphenylmethane diisocyanate, and or a polymeric MDI because it is hydrophobic by nature and as industry standard it has a low vapor pressure making it the safest polyisocyanate to use. The isocyanate is present in the polyurethane elastomer of the mold used in the method of the present invention in the range of about 3 to about 50 weight percent.

Commercially available MDI that can be used include it the present method: pure MDI, MDI isomers, modified MDI, prepolymers of MDI, polymeric MDI, and blends of these. A wide variety of these MDIs exist commercially under multiple trade names. For example, they can be purchased under the Rubinate trademark from Huntsman Chemical Company, Isonate trademark and Papi trademark from Dow Chemical Company, Mondur trademark from Bayer Company, and Luprinate trademark from BASF Corporation.

The polyols useful in the elastomers for the molds of the present invention include the polyoxyalkylene polyols having 2-8 hydroxyl groups and where the alkylene group has 2-6 carbon atoms. A large variety of polyols are available, obtained by polymerization of an alkylene oxide, such as ethylene oxide, propylene oxide, or polymerization of butylene oxide with a glycol. Polyethers having higher functionality may be obtained by the reaction with a triol or higher polyol, such as glycerine, trimethylol propane, pentaerythritol and sucrose. Polyols of the above types are available commercially, for example under the VORANOL trademark from Dow Chemical Company, ARCOL and ACCLAIM trademarks from ARCO Chemical Company (now Bayer), POLY-G trademark from Arch Chemical Company, MULTRANOL trademark from Bayer Corporation, and PLURACOL and PLURACOL HP trademark from BASF Corporation.

A catalyst is added to promote the rate of cure of the elastomer to provide a reasonable pot life and a reasonable cure rate at ambient temperatures, approximately 70° F. Any of the catalysts known in the production of polyurethane elastomers can be used. Examples include tertiary amine catalysts, or dibutyltin dilaurate or other organometal catalysts. A high performance organotin catalyst that has been used in curing the compositions of the present invention is FORMREZ UL-22 sold by Witco Chemical Company.

Prior to the first step of pouring the thermo-set material into a mold of the foregoing polyurethane elastomer in accordance with the method of the present invention, a master mold is fabricated in the shape of the hydrated thermo-set cast. The polyurethane elastomer is poured into the master mold and a backing is added to provide additional strength for the elastomer mold. The backing may be any suitable material of metal or wood. Typically a wooden tray is used to support the mold. The elastomer is cured in the molded shape while bonding to this wooden backing. The resulting polyurethane composite is removed from master mold and is ready for used as the elastomer mold.

In the concrete molding industry, the mold is often referred to as a form liner. Typically the polyurethane form liner is placed in a wooden form and the aqueous mixture is poured into the liner and held while the mixture fully hydrates to form the finished concrete product. The prior art form liner requires the addition of a mold release additive on the exposed surfaces of the liner to facilitate the removal of the liner after the concrete cures. These liners are then reused repeatedly and a hydrophobic is reapplied each time the aqueous mixture is poured into the mold for the next batch of the concrete product. Great care is necessary to keep the polyurethane from ripping while liner is pulled from the concrete product.

It has been found that these polyurethane elastomer liners develop fairly strong adhesion to the concrete. This is especially the case on the second pull in producing the second batch of the concrete product in the same liner. During the third pull of the next batch of concrete, the adhesion between the mold and the concrete causes the liner to begin to rip. The chief reason for this is that the concrete molder often misses the same spot on the mold due to its design. For example, deep undercuts exist in liner that is not covered with the hydrophobic additive.

### CONTROL AND EXAMPLE

The Examples and Control together with the following discussion illustrate the superior de-molding of concrete from polyurethane elastomer molds in accordance with the method of the present invention compared with that of the a polyurethane elastomer of the prior art. The control and example is for illustrative purposes and is not meant to limit the scope of the claims in any way.

The catalytically cured polyurethane elastomers used in the Examples and Control were made using standard techniques using a two component mixture well known in the polyurethane industry. One component was an isocyanate component of premixed materials and the second component was a polyol component of premixed polyols and catalyst. The isocyanate and polyol components were metered at a specified ratio by volume and mixed through a static mixer as the two component mixture was poured into a form to set up and cure at room temperature over a period of several days. Each component was made by proportionately blending the specific amounts of the materials listed in the Examples and Control below. The art of making molds is varied and standard in this industry. The urethane molds used in the Examples and Controls were simply in the form of a flat sheet for the sole purpose of demonstrating the release of the cured concrete from the sheet.

### Example 1

In this example a polyisocyanate component consisting of 2.0 functionality Rubinate LF1790 MDI prepolymer supplied by Huntsman was blended with a polyol component consisting of polypropylene glycol polyol (PPG) having a molecular weight of 6000 supplied by Bayer and a glycol having a molecular weight of 90, in a specified ratio using a high performance organotin catalyst consisting of Fomrez UL-22 supplied by Witco in an amount of 0.015 wt. % of the total blend. The isocyanate and polyol components were formulated into the blend according to polyurethane elastomer industry standards to maintain substantially stoichiometric ratios. Prior to blending the isocyanate and polyol components, a hydrophobic aromatic hydrocarbon oil consisting of Mariflex 1000 supplied by Ashland Chemical was added to each component so that the resulting cured polyurethane elastomer contains 35 wt. % of the hydrocarbon oil. The blend was then allowed to cure for 24 hours at room temperature in a form in the shape of a flat sheet. The resulting polyurethane elastomer had a Durometer hardness of 55 (Shore A).

Portland cement, sand, stone and water were added to a bucket in standard proportions well known in the concrete industry and stirred for about 10 mixtures until all of the solid materials formed a homogeneous mixture. This aqueous concrete mixture was poured onto the polyurethane elastomer sheet before hydration of the mixture occurred. The mixture was allowed to cure for 24 hours at room temperature. The elastomer sheet was then removed from the cured concrete via a lab pull test designed for this Example. Specifically, the lab pull test consisted of pouring a 2 inch square by ½ inch thick slab of concrete onto a 2 inch square flat sheet of the urethane elastomer having a thickness of ½ inch. A wire was placed into the concrete and it was allowed to cure four 2 days. The sample was placed in an Instron tensile machine and the urethane sheet was pulled 180 degrees away from the concrete slab. In the next batch, the same concrete mixture was poured onto the same 2 inch square area of the elastomer and pull test was repeated. This sequence of tests was repeated for a total of ten consecutive pulls on ten consecutive concrete slabs. In the first and second pulls of this example, no adhesion was noted and the sheet released easily even though no hydrophobic additive had been applied to the exposed surface of the elastomer sheet. Only a very small adhesion was noted, i.e., less then 2 lbs., for the following 3 pulls. The remaining pulls all stayed at this level indicating that the material would remain resistant to concrete bonding for repeated pulls thereafter. Specifically after ten pulls, the adhesion was found to be only 1.89 pounds per a 2 inch wide sample. The elastomer sheet containing the hydrophobic aromatic hydrocarbon oil was still in a usable condition with no damage after the ten pulls.

As shown in the Control below, a standard urethane mold that does not contain the hydrophobic additive could not be removed from the cured concrete on the second pull application without ripping the mold and rendering the mold unusable.

### Example 2

The method of Example 1 was repeated accept for the substitution of a hydrophobic chlorinated hydrocarbon for the aromatic hydrocarbon oil in the formulation of the polyurethane elastomer. In this example, the urethane elastomer contained 35% by weight of chlorinated paraffins consisting of Chlorowax LV supplied by Dover Chemical Corporation. A sheet of this elastomer was made in the same dimensions as in Example 1 and the same results were observed for two consecutive pulls of a cured concrete mixture from the sheet.

From the results of these two Examples, it can be seen that this invention produces a mold that will release from water based thermo-setting materials such as concrete without the addition of external mold release additives.

The hydrophobic additive can be pre-blended either with the isocyanate or polyol components prior to mixing or it can be added by itself to the two components as in the above Examples.

Control

In the control, substantially the same polyurethane elastomer used in the Examples was prepared except that the hydrophobic additive was not added to the blend to produce the elastomer sheet. The resulting standard urethane sheet was subjected to the same pull tests described in Example 1 above. The standard urethane sheet developed adhesion after only the second pull, by the third pull the adhesion was 21 lbs., and by the fourth pull the adhesion increased to 24 lbs. The third pull caused the beginning of a rip in the urethane surface of the sheet. Consecutive pulls after the fourth pull caused a drop in the adhesion due the urethane surface giving way into small pieces. The standard polyurethane elastomer was considered a failure at the third pull of 21 lbs. since this was too strong of a bond for the liner to be easily removed from the concrete and since the liner began ripping around 21 lbs.

Having disclosed exemplary embodiments, modifications and variations may be made to the disclosed embodiments while remaining within the scope of the invention as described by the following claims.

1. A method for producing a cast of a hydrated thermo-set material comprising:
pouring a fluid thermo-set material into a mold of a polyurethane elastomer containing at least about 5 percent of a hydrophobic additive based on the total weight of the elastomer;
curing the thermo-set material within the mold over a period of time; and
releasing the thermo-set material from the urethane mold.

2. The method of claim 1, wherein said hydrated thermo-set material is concrete prepared from a blend comprising Portland cement and water.

3. The method of claim 1, wherein said hydrated thermo-set material is prepared from a blend comprising gypsum and water.

4. The method of claim 1, wherein said hydrated thermo-set material is clay from a blend of clay and water.

5. The method of claim 1, wherein said polyurethane elastomer comprises a polyisocyanate and a polyol mixture.

6. The method of claim 5, wherein said polyisocyanate is selected from the group consisting of diphenylmethane diisocyanate (MDI), polymeric MDI, a modified MDI, and mixtures thereof.

7. The method of claim 5, wherein said polyol has a molecular weight in the range of about 50 to about 7000.

8. The method of claim 5, wherein said elastomer has a Durometer hardness in the range of about 5 (Shore A) to 80 (Shore D 80).

9. The method of claim 1, wherein said hydrophobic additive is present in the range of about 5 to about 80 percent based on the total weight of the elastomer.

10. The method of claim 1, wherein said hydrophobic additive is present in the range of about 20 to about 65 percent based on the total weight of the elastomer.

11. The method of claim 10, wherein said hydrophobic additive is selected from the group consisting of aromatic hydrocarbon oils, solvents with flash points greater than 100° F., chlorinated hydrocarbons, castor oil, and silicone fluids.

12. The method of claim 1, wherein the polyurethane mold is supported.

13. The method of claim 11, wherein the polyurethane mold is supported by a wood or metal tray.

14. A method for producing a cast of a hydrated thermo-set material comprising:
pouring an aqueous mixture of a thermo-set material selected from the group consisting of Portland cement, gypsum, clay, and mixtures thereof into a mold of a polyurethane elastomer containing in the range of about 5 to about 80 percent of a hydrophobic additive selected from the group consisting of aromatic hydrocarbon oils, solvents with flash points greater than 100° F., chlorinated hydrocarbons, castor oil, and silicone fluids based on the total weight of the elastomer, said elastomer having a Durometer hardness in the range of about 5 (Shore A) to 80 (Shore D 80) and comprising a polymeric diphenylmethane diisocyanate by itself or blended with a modified diphenylmethane diisocyanate and a polyol having a molecular weight in the range of about 50 to about 7000;
curing the thermo-set material within the mold over a period of time; and
releasing the thermo-set material from the mold.

15. The method of claim 14, wherein said hydrophobic additive is present in the range of about 20 to about 65 percent based on the total weight of the elastomer.

16. The method of claim 14, wherein the polyurethane mold is supported by a wood or metal tray.
